(19) United States
(12) Patent Application Publication
(10) Pub. No.: US 2015/0040844 A1
(43) Pub. Date: Feb. 12, 2015

(54) ELECTRONIC CONTROL UNIT AND METHOD FOR REGULATING THE DISBURSEMENT OF HYDROGEN AND OXYGEN

(71) Applicant: Hydro Phi Technologies, Inc., Doraville, GA (US)

(72) Inventors: Jonathan Goldman, Marietta, GA (US); Doug King, Canton, GA (US); Reid Meyer, Newnan, GA (US); Chris Petty, Winder, GA (US); Basil Lee Winslett, Kennesaw, GA (US); Jackie Lee, Hoschton, GA (US)

(21) Appl. No.: 14/455,299

(22) Filed: Aug. 8, 2014

Related U.S. Application Data
(60) Provisional application No. 61/863,793, filed on Aug. 8, 2013.

(51) Int. Cl. F02B 43/12; F02M 21/02

(52) U.S. Cl. CPC F02B 43/12; F02M 21/0206; F02B 2043/106
USPC 123/3

(57) ABSTRACT

An apparatus that regulates a flow of hydrogen and oxygen generated by fuel cells as supplemental fuel for an internal combustion engine, in which a microprocessor controller receives engine operating parameters, determines a fuel demand for the engine responsive to the operating parameters, and regulates the supply of power to the fuel cells for generating the supplemental fuel. A supply body holds process water supplied to the fuel cells. The generated hydrogen and oxygen communicate to an intake manifold of the engine. A method of regulating the disbursement of hydrogen and oxygen for supplemental fuel for an engine is disclosed.

### TECHNICAL FIELD

The present invention relates to systems providing supplemental fuel to internal combustion engines. More particularly, the present invention relates to apparatus and methods for the regulation and control of the disbursement of hydrogen and oxygen gas created from a gas generator for use as an on-demand supplemental fuel additive for improved performance in internal combustion engines.

### BACKGROUND OF THE INVENTION

A fuel cell traditionally is a device that combines hydrogen and oxygen gases to generate electricity and water. A fuel cell comprises a pair of spaced-apart plates and a process water. An assembly having a plurality of such spaced-apart plates is known as a stack. The assembly has also been referred to as a fuel cell. However, the term “fuel cell” has also come to refer to devices that generate pure hydrogen and oxygen on-demand, for example, for use as a fuel for engines. The present application uses the term “fuel cell” to refer to a gas generation device. In a first embodiment, the gas generation device is a reverse fuel cell (traditional definition such as an assembly or stack of fuel cells); in a second embodiment, the gas generation device is an electrolyzer also known as a proton exchange membrane device (PEM). Electrolysis cells have long been used to generate on-demand mixed-gas fuel additives known as ‘oxy-hydrogen,’ ‘hydroxy,’ ‘HHO,’ or ‘Brown's Gas’ for use in traditional internal combustion engines. While such fuel cell gas generation systems have provided supplemental fuel to internal combustion engines, there are drawbacks involving the control of the generation of the supplement fuel.

The control of these supplemental fuel systems has generally been limited to managing the output of the fuel cell to maintain a steady-state output regardless of changing system parameters, such as cell temperature or electrolyte concentration.

Electrolysis cells are typically managed by varying the time-averaged amperage delivered to the cell through electronic means for ‘pulse-width modulation’ of the power supplied to the cell. The motivations to manage cell operation primarily arises from the need to militate against the tendency for these cells to overheat during operation. An overheated fuel cell may enter into a run-away thermal condition. This results in an undesirable increase in amp-draw and may cause damage to the power sources, typically alternators or battery systems. Thus, the control systems heretofore known maintain a constant flow rate of the fuel additive into the engine, but fail to match the supplemental fuel additive to the instantaneous need of the engine based upon engine operating factors such as engine load, rpm, turbo boost pressure, etc.

These known control systems classically introduce the fuel additive gas—pure hydrogen and oxygen, H₂ & O₂, separately, from a PEM electrolyzer-type fuel cell; or hydroxy from an electrolysis cell—in a fixed stoichiometric proportion: 2 moles of hydrogen for every mole of oxygen. These control systems have heretofore been unable to affect this ratio consistently and reliably, which can be important during different phases of a load curve for an operating engine.

Furthermore, typical control systems that manage a constant flow rate ignore the need to accommodate a higher dynamic flow range that might arise from a need to go from air/fuel ratios found in typical gasoline vehicles (14.7:1) to ultra-lean mixtures found in diesel engines at no-load or low-load conditions of greater than 100:1 air/fuel ratios. This need for high dynamic flow range may require the control system to deliver instantaneously or, for very short periods, a flow rate that is larger than the total system output. Thus, there is a need for some amount of storage that can enable short bursts of high flow rates.

Accordingly, there is a need in the art for an improved control system and method to manage the generation and delivery of hydrogen and oxygen gas from electrolysis or PEM devices for supply as supplemental fuel to internal combustion engines. It is to such that the present invention is directed.

### SUMMARY OF THE INVENTION

The present invention meets the need in the art with an apparatus that regulates a supply of hydrogen and oxygen as a supplemental fuel for an internal combustion engine, comprising a supply body for holding a volume of a process water and a gas generation apparatus for generating a supply of a hydrogen/oxygen supplemental fuel using a flow of the process water communicated from the supply body to the gas generation apparatus. A gas manifold for receiving the hydrogen/oxygen supplemental fuel generated by the gas generator connects between the gas generator and an intake manifold of an internal combustion engine for communicating a flow of the hydrogen/oxygen supplemental fuel to the internal combustion engine. A power controller is configured for operating the gas generation apparatus. A microprocessor controller is configured for receiving engine signals from an electronic control module of an internal combustion engine providing real-time engine operating parameters, determining a fuel demand for the engine responsive to the operating parameters of the engine, and regulating the operation of the power controller to generate the supplemental fuel provided to the engine. The flow rate of the generated hydrogen/oxygen supplemental fuel varies based on the fuel demand of the operating internal combustion engine.

In another aspect, the present invention provides a method of regulating a supply of hydrogen and oxygen as a supplemental fuel for an internal combustion engine, comprising the steps of:

(a) receiving by a microprocessor controller engine signals from an electronic control module of an internal combustion engine providing real-time engine operating parameters;

(b) determining a fuel demand for the engine responsive to the operating parameters of the engine;

(c) regulating the operation of a power controller for providing a selected amount of power to a gas generation apparatus for generating a supply of a hydrogen/oxygen supplemental fuel using a flow of process water communicated from a supply body to the gas generation apparatus; and

(d) communicating the generated supplemental fuel to an intake manifold of the engine as a supplemental fuel to meet the determined fuel demand of the engine,

whereby the flow rate of the generated hydrogen/oxygen supplemental fuel varies based on the fuel demand of the operating internal combustion engine.

Objects, advantages, and features of the present invention will become apparent upon a reading of the following detailed description of the invention in conjunction with the drawings and the appended claims.

### BRIEF DESCRIPTION OF THE DRAWINGS

FIG. 1 illustrates in schematic view an exemplary embodiment of a fuel cell control system in accordance the present invention consisting of a cell logic controller, cell power controls, and fuel cells.

FIG. 2 illustrates in schematic view an exemplary embodiment of the fuel cell control system using a fuel cell that generates hydrogen and oxygen with a chemical Faraday electrolysis process.

FIG. 3 illustrates in schematic view an exemplary embodiment of the fuel cell control system using a fuel cell that generates hydrogen and oxygen with a proton exchange membrane.

### DETAILED DESCRIPTION

The present invention recognizes the shortcomings of modern hydrogen electronic control units (HECUs) for reverse fuel cells (electrolysis units), and provides a computer-configured interface with independent engine and exhaust sensors and the native vehicle's electronic control unit (ECU) or vehicle electronic control module (ECM) for controlling the generation of a supplemental fuel by a gas generator. The present application will refer to the term “fuel cell” as either an electrolyzer device or a reverse fuel cell device for generating mixed hydrogen and oxygen gases or separate H₂ and O₂, respectively. The control apparatus operates with any type of fuel cell that disassociates water into its gaseous constituents, such as fuel cells that operate with traditional Faraday electrolysis cells or a reverse operation fuel cell having a proton exchange membrane also known as ‘PEM’ stacks or polymer electrolyte membranes. The apparatus provides a computer-configured electrical control unit that controls at least one fuel cell, but preferably a plurality of interconnected fuel cells. The computer is configured for regulating the flow of hydrogen and oxygen into the air intake manifold, or the fuel rail, of internal combustion engines based upon actual data coming from the vehicle's electronic control unit or vehicle control module. The apparatus and computer-configured electronic control unit that controls the fuel cells also functions to regulate the flow of hydrogen and oxygen into the air intake manifold or fuel rail, of a stationary reciprocating engine-powered generator based upon the actual data coming from the generator's electronic control unit or electronic control module. The apparatus and computer-configured electronic control unit that controls the fuel cells also regulates the flow of hydrogen and oxygen into the air intake stage or fuel rail of a power turbine, micro-turbine or other rotating engine based upon the actual data coming from the turbine's electronic control unit, electronic control module or supervisory controller.

According to one embodiment of the invention, the control system includes a computer-configured cell logic controller with online and mobile capability, a network of current sensors, cell power controllers, fuel cells, gas manifold and gas connectors, and a “Y block” to combine the H₂ and O₂ flows and connect the supplemental fuel supply system to the air intake or turbo of an internal combustion engine.

According to another embodiment of the invention, the apparatus comprises sensors that measure engine parameters such as torque, revolutions per minute, load, engine turbo pressure ratios, oxygen concentration, and airflow. The apparatus may include the measurement of other engine exhaust parameters, such as combustion byproducts or exhaust gas temperatures. The apparatus compares engine exhaust parameters to an empirically or algorithmically determined flow requirement.

To regulate the flow of hydrogen and oxygen, a computer-configured control algorithm varies individual cell output flows, by adjusting the power to each individual fuel cell through a variety of methods or, in a less granular fashion, switching particular cells ‘on’ and ‘off’ for periods that coincide with the variation in engine demand. A device such as a pulse-width modulator may be used for switching fuel cells on and off in real-time.

By creating a system that measures the instantaneous demands of the engine, and mapping those needs to the capabilities and rates provided by the H₂ & O₂ from one or more fuel cells, a computer-configured control algorithm, from source code, emerges that provides an analogous hydrogen fuel map that operates the system, wherein the source code is in the form of a spreadsheet.

According to another embodiment of the invention, the hydrogen fuel map can be optimized for hydrocarbon fuel reduction, emissions reduction, or some best compromise of both goals. The hydrogen fuel map will specify the ideal gas flow rates of H₂ & O₂ from one or a series of fuel cells or hydroxy fuel additive from one or a series of electrolysis cells for a given engine state (load, rpm, turbo boost pressure, etc.). The apparatus may then electronically control the output of the individual cells to achieve the required total output that is matched with the actual needs of the internal combustion engine.

Another embodiment includes control schemas with a pressurized container that injects hydrogen and oxygen into the inlet high-pressure side of the turbocharger. A pressurized containment system provides the ability to inject hydrogen and oxygen at a higher rate dependent upon specific engine parameters.

It is to be understood that both the foregoing general description and the following detailed description are exemplary and explanatory only, and are not restrictive of the invention as claimed. While the foregoing general description and following detailed description focus on engine applications for mobile platforms, the same or similar apparatus and control schemas apply to other applications such as reciprocating engine-powered generators, turbines, microturbines and other rotating engines used for power generation.

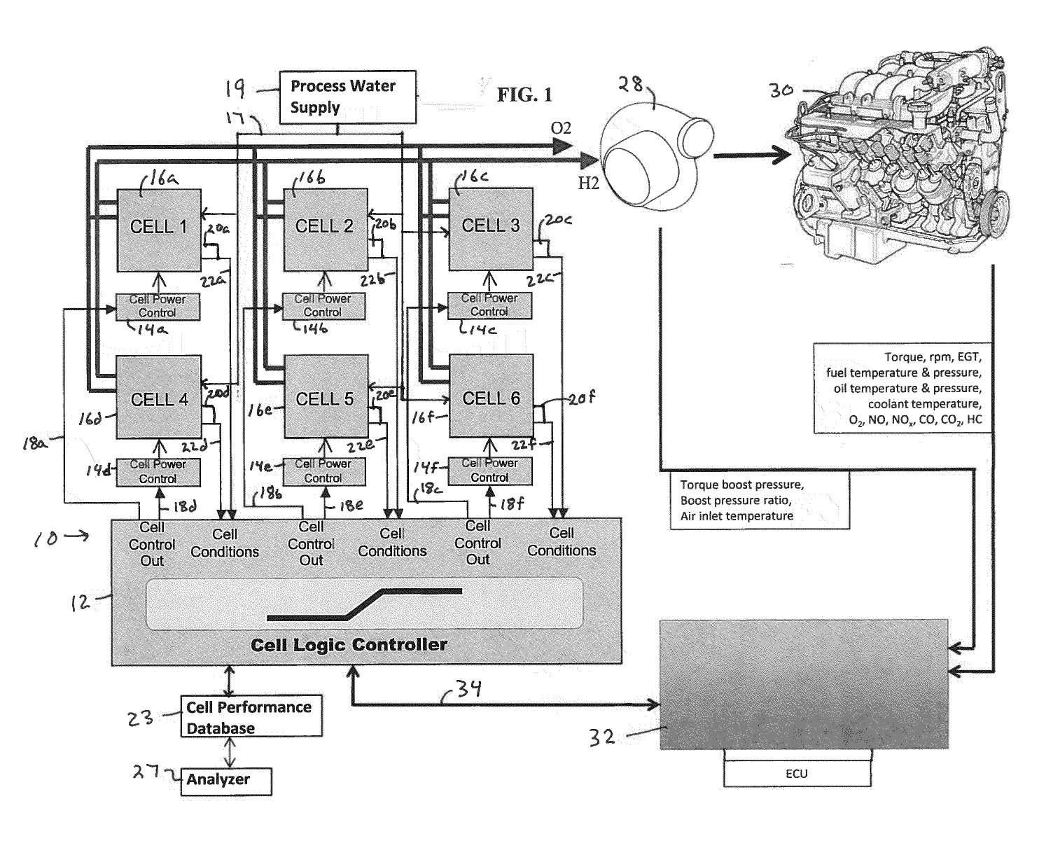

With reference to the drawings, in which like parts have like reference numerals, FIG. 1 illustrates in schematic view an exemplary embodiment of a gas generating system 10 in accordance with the present invention, which in the illustrative embodiment provides a fuel cell control system consisting of a cell logic controller 12, a plurality of cell power controls 14, and a plurality of fuel cells 16. Each fuel cell 16 is associated with a respective one of the cell power controls 14. The cell logic controller 12 is microprocessor device configured for system operation as discussed below. Each cell power controller 14 conventionally connects to a source of power for driving the respective fuel cell 16. Each cell power controller 14 communicates 18 with the cell logic controller 12 that directs the power supplied through the respective cell power controller 14 to its driven fuel cell 16. Sensors 20 generally monitor the performance of each respective fuel cell and communicate 22 with the cell logic controller 12. The sensors 20 track the operating parameters of the fuel cell. These operating parameters include the current, voltage, flow output, and cell temperature. In an alternate embodiment, the cell logic controller 12 communicates with a database 23 to record the operating parameters and performance of each of the gas generator devices or fuel cells 16. An analyzer 27 is configured for evaluating the data as to each of the fuel cells for monitoring performance, replacement, and operational characteristics. The analyzer 27 may be a separate microprocessor device or may be the cell logic controller 12.

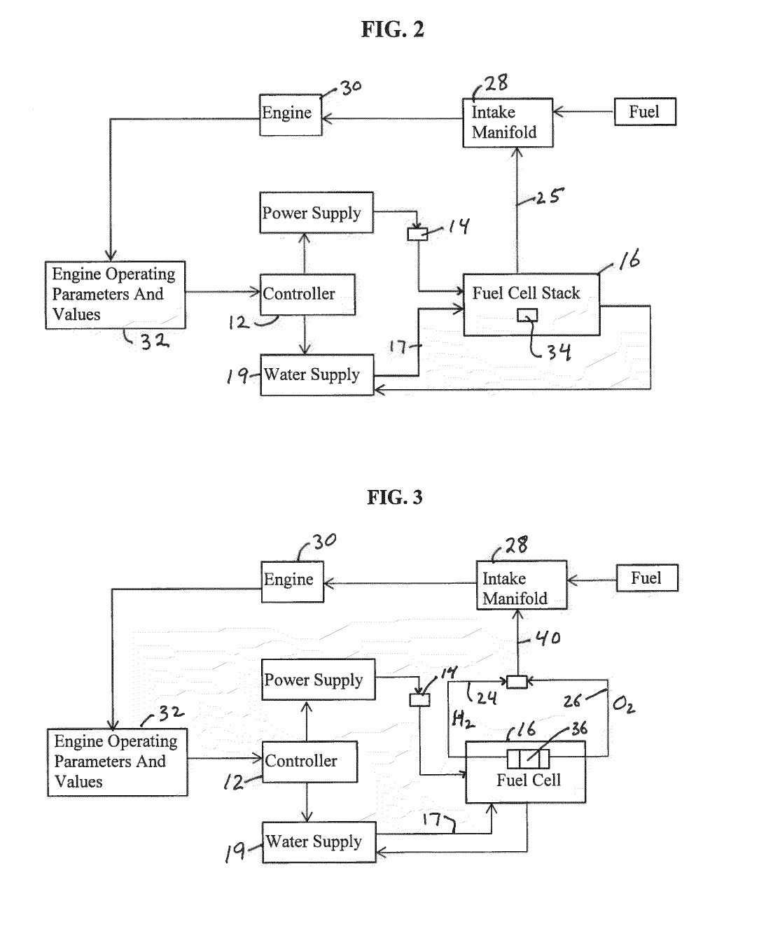

Each fuel cell 16 receives 17 process water from a supply 19. The fuel cell 16 generates hydrogen and oxygen and the flow rate is based on the current supplied by the cell power controller 14 as directed by the cell logic controller 12. The generated flow of hydrogen and oxygen communicates through respective conduits 24, 26 that connect from the fuel cell output ports to an intake manifold or turbocharger 28 of an internal combustion engine 30. The engine 30 conventionally connects to an engine control unit 32 for sensing operating parameters of the engine. These parameters include, but are not limited to, torque, rpm, EGT, fuel temperature and pressure, oil temperature and pressure, coolant temperature, and exhaust information including temperature and exhaust gas by-products including O₂, NO₂, NOₓ, CO, CO₂ and HC. The turbocharger 28 includes sensors that sense and communicate turbo boost pressure, boost pressure ratio, and air inlet temperature. The ECU data is provided 34 to the cell logic controller 12, for example, through a common bus. It is to be appreciated that FIG. 1 illustrates the gas generation device employing PEM stacks because outputs are depicted for each of the hydrogen gas and the oxygen gas sources separately. An alternate embodiment of the gas generation device employing a Faraday-type fuel cell (see FIG. 2) employs a single conduit 25 for communicating the output of the mixed hydrogen and oxygen gases to the manifold or turbocharger.

FIG. 2 illustrates in schematic view an exemplary embodiment of the fuel cell control system 10a, in which the fuel cells 16 generate mixed hydrogen and oxygen gases, alternatively known as ‘oxy-hydrogen,’ ‘hydroxy,’ ‘HHO,’ or ‘Brown's Gas’ with a chemical Faraday electrolysis process. The power supplied to the fuel cell from the cell power controller 14 causes the electrolysis unit 34 to separate the process water into constituent hydrogen and oxygen, though mixed together, that communicates through the supply conduit 25 to the intake manifold 28 of the engine 30 for a supplemental fuel.

FIG. 3 illustrates in schematic view an exemplary embodiment of the fuel cell control system 10b, in which the fuel cells 16 generate hydrogen and oxygen in a reverse process fuel cell having a proton exchange membrane 36 that causes separation of some of the process water into constituent hydrogen and oxygen that communicates through a supply conduit 25 to the intake manifold 28 of the engine 30 for a supplemental fuel. FIG. 3 further illustrates an alternate embodiment in which the respective supplemental fuel supply lines 24, 26 connect through a “y” connector or manifold 38 and a single supplemental fuel supply conduit 38 communicates the supplemental fuel to the intake manifold or turbocharger 28 through the “y” connector 40.

The apparatus 10 of the present invention provides a control architecture that enables the flexible addition, deletion and reconfiguration of end control devices and sensors that monitor and control engine parameters either through direct connection or through standard, protocol-based communications channels such as CANBUS, or other industry-relevant standards.

ECU/ECM data, available from On-Board Data 2 (OBD2), CANBUS or other computer programmed measurements, are delivered to the computer-configured cell logic controller in real-time to serve as control inputs.

The computer-configured cell logic controller 12 consists of sensors and sensory devices that processes actual engine performance parameters, such as engine torque, rpm, turbo boost pressure, turbo boost inlet/outlet pressure ratio, exhaust gas temperature (EGT), engine manifold temperature, air inlet temperature, fuel temperature and pressure, oil temperature and pressure, coolant temperature, oxygen (O₂) sensor, NO or NOₓ sensor, CO sensor, CO₂ sensor, or hydrocarbon (HC) sensor.

These sensor inputs, when combined with the concomitant hydrogen map, will produce a computed demand for hydrogen and oxygen (in the case of a reverse fuel cell) or a demand for hydroxy (in the case of an electrolysis cell) that reflects the appropriate air-to-fuel (A/F) ratio. The demand for hydrogen and oxygen, or hydroxy, is satisfied by modulating the output of one or more fuel cells 16, or the output of one or more electrolysis cells 16, by using power management techniques such as pulse-width modulation (PWM) to instantaneously reduce or increase the gas flow rate from each cell, whether a reverse fuel cell or an electrolysis cell. The sum of the flow output of each individual cell, when fed into a gas distribution manifold 28 satisfies the desired total flow. A variation or change in the pulse profile will determine how much fuel additive goes in.

The device is powered by an alternator and batteries on the motor vehicle. The power may derive from either a 5-, 12- or 24-volt direct current power supply. Alternatively, the gas generation devices may be powered by higher voltages found on stationary reciprocating equipment of turbo-machinery, typically, 110/220V; 240V, 480V or similar.

The data from the ECU 32 (Engine Control Unit) is processed by the computer-configured hydrogen cell logic controller 12 (or HECU), which is connected to the ECU or ECM via DATA BUS and decodes sensor signal information. The DATA BUS links the two boards together to distribute the sensor information.

The computer-configured cell logic controller 12 processes actual engine data, along with the computer-configured hydrogen fuel map, and based upon computer-configured data executes a control program, having source code, that controls the amount of power to send to each fuel cell 16 through the fuel cell controller 14. Fuel cell conditions, such as current, voltage, gas flow measurement and cell temperature continuously run on a feedback loop from each individual fuel cell 16 to the cell logic controller 12 via connections 22 to the HECU control board. Based upon computer-configured data, the cell logic controller drives the cell power controller 14 by varying the effective voltages causing the cell 16 to receive current responsive the engine operating demand; for example, increasing the effective voltage causes the cell 16 to draw more current under full acceleration or increased fuel needs of the engine 30.

In a first embodiment of the invention, the control computer 12 is configured for providing that the aforementioned sensor inputs, when combined with the concomitant hydrogen map, produces a computed demand for hydrogen and oxygen in the case of a reverse fuel cell, or a demand for hydroxy in the case of a standard chemical electrolysis cell, that reflects the appropriate air/fuel ratio. The demand is then satisfied by activating one, several or all the cells 16 to match the desired demand. In this embodiment, the fuel cells 16 operate either “on” at full rate for hydrogen/oxygen gas production or “off” for no hydrogen/oxygen gas production.

For example, if there are n cells, each capable of delivering x standard liters per minute (SLM), then the total flow output available would be nx SLM. If n>1, then the possible delivery rates under this scheme would be x, 2x, 3x, . . . (n−1)x, and nx, depending upon the number of cells activated at any given time.

In another embodiment of the invention, the apparatus provides that the demand is then satisfied by activating one or more cells 16, each of which having a flow output that may be individually modulated by using power management techniques, such as pulse-width modulation (PWM), to instantaneously reduce or increase the flow rate from each fuel cell 16 or electrolysis cell. Each individually modulated cell 16, may, in turn, be used individually or in concert cooperatively with other cells by being turned either on, at its own modulated level, or off altogether to achieve an intermediate flow output level. In this case, each cell 16 may be, at any instant in time, ‘ON’ at full power, ‘ON’ at a globally determined PWM'd (intermediate) power level, or OFF, so all fuel cells are operated the same level or rate.

In yet another embodiment of the invention, the apparatus provides that the demand is then satisfied by activating one or more cells 16, each of which has a flow output that may be individually modulated by using power management techniques such as pulse-width modulation (PWM) to instantaneously reduce or increase the flow rate from each fuel cell. Each individually modulated cell 16 may have a different power setting for each flow setpoint. Each individually modulated cell 16, may in turn, be used individually or in concert with other cells by being turned either on, at its own respective modulated level or off altogether to achieve an intermediate flow output level. This embodiment would provide the greatest resolution of flow differentiation, so each cell operates at an independent and individual percentage of its power rating. The controller 12 is configured for not only operating each fuel cell 16 independently, but also tracking the operation and production of flow from each respective cell.

In yet another embodiment of the invention, each individually modulated fuel cell 16 may have a different power setting for each flow setpoint. Further, each individually modulated cell may be driven, for relatively short periods of time, beyond its rated flow output capacity so as to achieve, on a time-averaged basis, a substantially larger system flow capacity. This may be useful, for example, for engines during their highest load phase, such as accelerating while climbing a grade. Each individually modulated cell 16, may in turn, be used individually or in cooperation with other of the fuel cells by being turned either on, at its own modulated level or off altogether to achieve an intermediate flow output level. This embodiment is similar to the prior one, except the controller permits, for brief periods, operation of the cells at levels exceeding a 100% maximum power rating. This last embodiment may be particularly useful in managing flow should there be a failure of one or more cells on a system consisting of multiple cells.

For each embodiment described where individual cells may be turned on or off to achieve an incremental increase or decrease in flow rate, an algorithm may be employed to rotate cells in and out of usage based upon accumulated run times so as to effectively level the duty-cycles experienced by each individual cell. This rotation approach may be applied to all the schemes outlined above.

Since fuel cells generally have an optimum operational temperature, the embodiments and computer-configured algorithms, having source code, described above may also be used to manage the temperature of these cells. Individual cells may be turned on and off or modulated as described above to ensure all cells are operating at their optimum capacity. An illustrative exemplary embodiment provides five fuel cells 16, each having a common rated flow capacity. If the total flow capacity required by the operating engine 30 may be supplied by four cells, there are several ways to achieve this: i) run all five cells at 80% of their rated capacity, or ii) shut one of the cells off for a period (such as if a cell is in an ‘over-temperature’ condition and allow it to cool off), and run the other four cells at 100% of their rated capacity.

Since desired fuel cell flow outputs are typically modeled and characterized by mapping outputs to fuel cell control parameters such as current and voltage, the ultimate desired fuel cell output is usually controlled through one or both of these parameters. However, it is known that control parameters can drift over time and that flow outputs can change. Thus the accuracy of the HECU is only as good as the agreement between the desired flow characteristic and the cell control parameters.

As such, it is desirable to have real-time feedback on flow output, either of each individual cell or on the entire array of fuel cells or electrolysis cells. Generally speaking, it is difficult to find accurate flow rate instruments that are tolerant of moisture (in case of a fuel cell) or, even caustic moisture streams in the case of some electrolysis cells. However, there are some silicon, silicon carbide or similar micromachined microbridge mass airflow meters that can provide real-time measurement of flow. These instruments can be used at the output of each cell to provide a constant calibration to the HECU mapping capability or can be used at the combined output of a system gas manifold to proportionally change cell outputs to maintain desired flow rates through the use of a standard PID control algorithm.

Further, it is well-known that the purity of the distilled water used in PEM-based electrolysis systems has a predominant impact on the life of a PEM stack. Typically, PEM stack fuel cell systems that use so-called ‘Type I’ distilled water (18 megaohm-cm resistivity) can have operational lifetimes of tens of thousands of hours. Type II distilled water (1 part per million total dissolved solids or 1 ppm TDS or 500,000 ohm-cm resistivity) is more commonly seen on mobile transportation platforms and will result in shorter PEM stack life. The failure mode is typically seen as a reduction of voltage, and a concomitant reduction in amp-draw. By using the available mass airflow sensors described above, it is possible for the analyzer to monitor the health of the PEM stack in real-time. This performance information can be used by the HECU to allocate power to the other stacks in a multi-stack system to compensate for output lost to the decay in output of one or more stacks. In addition, the real-time flow monitoring capability, when analyzed against the applied current can signal the PEM stack's end-of-life (EOL) condition, and indicate when it is time to replace the under-performing stack.

The foregoing discloses an apparatus and method for management and control of gas generation devices that generate hydrogen and oxygen gas, such as from fuel cells, for supplemental fuel supplied to an intake manifold of an internal combustion engine. While the invention has been described with respect to various illustrative embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. An apparatus regulating a supply of hydrogen and oxygen as a supplemental fuel for an internal combustion engine, comprising:
a supply body for holding a volume of a process water;
a gas generation apparatus for generating a supply of a hydrogen/oxygen supplemental fuel using a flow of the process water communicated from the supply body to the gas generation apparatus;
a gas manifold receiving the hydrogen/oxygen supplemental fuel generated by the gas generator and to an intake manifold of an internal combustion engine for communicating a flow of the hydrogen/oxygen supplemental fuel to the internal combustion engine;
a power controller configured for operating the gas generation apparatus; and
a microprocessor controller configured for receiving engine signals from an electronic control module of an internal combustion engine providing real-time engine operating parameters, determining a fuel demand for the engine responsive to the operating parameters of the engine, and regulating the operation of the power controller to generate the supplemental fuel provided to the engine,
whereby the flow rate of the generated hydrogen/oxygen supplemental fuel varies based on the fuel demand of the operating internal combustion engine.

2. The apparatus as recited in claim 1, wherein the gas apparatus comprises a fuel cell.

3. The apparatus as recited in claim 1, wherein the hydrogen/oxygen supplemental fuel comprises a hydrogen gas and an oxygen gas.

4. The apparatus as recited in claim 1, wherein the gas generation apparatus comprises a reverse flow fuel cell.

5. The apparatus as recited in claim 1, wherein the hydrogen/oxygen supplemental fuel comprises a hydroxy mixture.

6. The apparatus as recited in claim 1, wherein the gas generation apparatus uses the provided process water in a chemical Faraday electrolysis process to generate the hydrogen/oxygen supplemental fuel.

7. The apparatus as recited in claim 1, wherein the gas generation apparatus uses a proton exchange membrane to generate the hydrogen/oxygen supplemental fuel.

8. The apparatus as recited in claim 1, wherein the regulation of the operation of the power controller comprises changing the effective voltage or current provided to the gas apparatus.

9. The apparatus as recited in claim 4, wherein the effective voltage is increased in order for the gas generator to draw more current based on the fuel demand requiring increased fuel needs for the engine.

10. The apparatus as recited in claim 1, wherein the engine signals comprises a plurality of signals, each representing a respective engine operating parameter of torque, revolutions per minute, load, turbo boost pressure, turbo boost inlet/outlet pressure ratio, oxygen concentration, and airflow.

11. The apparatus as recited in claim 10, wherein the engine signals further comprise a combustion byproducts signals.

12. The apparatus as recited in claim 10, further comprising a signal representing exhaust gas temperature.

13. The apparatus as recited in claim 1, further comprising a power management device modulates a pulse-width of the current to change the flow rate of the hydrogen/oxygen supplemental fuel generated by the gas generator.

14. The apparatus as recited in claim 1, wherein the gas generator comprises a plurality of fuel cells.

15. The apparatus as recited in claim 14, whereupon a determination of the fuel demand, the power controller is configured to supply a current to each of the plurality of fuel cells.

16. The apparatus as recited in claim 15, wherein the power controller is configured for supplying a respective current to each of the plurality of fuels cells independently.

17. The apparatus as recited in claim 15, wherein each of the fuel cells is independently modulated as a percentage of full power.

18. The apparatus as recited in claim 15, wherein the power controller is configured for operating each fuel cell at a respective power setting for each of a plurality of total system flow setpoints.

19. The apparatus as recited in claim 15, wherein the power controller drives at least one of the fuel cells at a power setting greater than the rated flow output of the fuel cell.

20. The apparatus as recited in claim 14, further comprising an analyzer that tracks usage of each fuel cell over a rolling predetermined period, whereby the power controller is configured to rotate usage of the fuel cells.

21. The apparatus as recited in claim 14, further comprising a temperature sensor associated with each of the fuel cells, which temperature sensor communicates a signal representative of the fuel cell temperature to the power controller, whereby the controller adjusts the modulation of the fuel cell to maintain the fuel cell within a selected temperature range.

22. The apparatus as recited in claim 14, further comprising the controller configured for receiving feedback data as to process output from the operation of each one of the plurality of fuel cells, determining expected output thereof based on the power supplied to said one of the plurality of fuel cells, and comparing the process output and the expected output, whereby the controller adjusts the modulation of said one of the plurality of fuel cells to maintain the fuel cell performing to expected output.

23. A method of regulating a supply of hydrogen and oxygen as a supplemental fuel for an internal combustion engine, comprising the steps of:
(a) receiving by a microprocessor controller engine signals from an electronic control module of an internal combustion engine providing real-time engine operating parameters;
(b) determining a fuel demand for the engine responsive to the operating parameters of the engine;
(c) regulating the operation of a power controller for providing a selected amount of power to a gas apparatus for generating a supply of a hydrogen/oxygen supplemental fuel using a flow of process water communicated from a supply body to the gas apparatus; and
(d) communicating the generated supplemental fuel to an intake manifold of the engine as a supplemental fuel to meet the determined fuel demand of the engine,
whereby the flow rate of the generated hydrogen/oxygen supplemental fuel varies based on the fuel demand of the operating internal combustion engine.

24. The method as recited in claim 23, further comprising the step of receiving the hydrogen/oxygen supplemental fuel in a gas manifold prior to step (d).

25. The method as recited in claim 23, wherein the gas apparatus comprises a fuel cell.

26. The method as recited in claim 23, wherein the hydrogen/oxygen supplemental fuel comprises a hydrogen gas and an oxygen gas.

27. The method as recited in claim 23, wherein the gas apparatus comprises a reverse flow fuel cell.

28. The method as recited in claim 23, wherein the hydrogen/oxygen supplemental fuel comprises a hydroxy mixture.

29. The method as recited in claim 23, wherein the gas apparatus uses the provided process water in a chemical Faraday electrolysis process to generate the hydrogen/oxygen supplemental fuel.

30. The method as recited in claim 23, wherein the gas generation apparatus uses a proton exchange membrane to generate the hydrogen/oxygen supplemental fuel.

31. The method as recited in claim 23, wherein the regulation of the operation of the power controller comprises the step of changing the effective voltage or current provided to the gas apparatus.

32. The method as recited in claim 31, wherein the effective voltage is increased in order for the gas apparatus to draw more current based on the fuel demand requiring increased fuel needs for the engine.

33. The method as recited in claim 23, wherein the engine signals comprises a plurality of signals, each representing a respective engine operating parameter of torque, revolutions per minute, load, turbo boost pressure, turbo boost inlet/outlet pressure ratio, oxygen concentration, and airflow.

34. The method as recited in claim 33, wherein the engine signals further comprise a combustion byproducts signals.

35. The method as recited in claim 33, further comprising a signal representing exhaust gas temperature.

36. The method as recited in claim 23, further comprising the step of modulating a pulse-width of the current provided to the gas apparatus to change the flow rate of the hydrogen/oxygen supplemental fuel generated by the gas apparatus.

37. The method as recited in claim 23, wherein the gas apparatus comprises a plurality of fuel cells.

38. The method as recited in claim 37, whereupon a determination of the fuel demand, the power controller is configured to supply a current to each of the plurality of fuel cells.

39. The method as recited in claim 37, wherein the power controller is configured for supplying a respective current to each of the plurality of fuels cells independently.

40. The method as recited in claim 37, wherein each of the fuel cells is independently modulated as a percentage of full power.

41. The method as recited in claim 37, wherein the power controller is configured for operating each fuel cell at a respective power setting for each of a plurality of total system flow setpoints.

42. The method as recited in claim 37, wherein the power controller drives at least one of the fuel cells at a power setting greater than the rated flow output of the fuel cell.

43. The method as recited in claim 36, further comprising an analyzer that tracks usage of each fuel cell over a rolling predetermined period, whereby the power controller is configured to rotate usage of the fuel cells.

44. The method as recited in claim 36, further comprising a temperature sensor associated with each of the fuel cells, which temperature sensor communicates a signal representative of the fuel cell temperature to the power controller, whereby the controller adjusts the modulation of the fuel cell to maintain the fuel cell within a selected temperature range.

45. The method as recited in claim 36, further comprising the controller configured for receiving feedback data as to process output from the operation of each one of the plurality of fuel cells, determining expected output thereof based on the power supplied to said one of the plurality of fuel cells, and comparing the process output and the expected output, whereby the controller adjusts the modulation of said one of the plurality of fuel cells to maintain the fuel cell performing to expected output.
